(19) United States
(12) Patent Application Publication
(10) Pub. No.: US 2025/0203300 A1
(43) Pub. Date: Jun. 19, 2025

(54) CONTRALATERAL-HEARING INTERFERENCE REDUCTION

(71) Applicant: Starkey Laboratories, Inc., Eden Prairie, MN (US)

(72) Inventors: Jacques André Grange, Wales (GB); Thomas Burns, St. Louis Park, MN (US)

(21) Appl. No.: 18/974,909

(22) Filed: Dec. 10, 2024

Related U.S. Application Data
(60) Provisional application No. 63/609,959, filed on Dec. 14, 2023.

(51) Int. Cl. H04R 25/00

(52) U.S. Cl. CPC H04R 25/554; H04R 25/606; H04R 25/70; H04R 2460/01

(57) ABSTRACT

Various embodiments of a hearing device system are disclosed. The system includes a first hearing device, a second hearing device, and a receiver operatively coupled to one or both of the first hearing device and the second hearing device. The system further includes a controller configured to provide a receiver signal to the receiver based on at least one of a first audio signal received from the first hearing device or a second audio signal received from the second hearing device, determine a first signal to noise ratio of the first audio signal, and determine a second signal to noise ratio of the second audio signal. The controller is further configured to compare the first signal to noise ratio and the second signal to noise ratio, and modify the receiver signal based on a difference between the first signal to noise ratio and the second signal to noise ratio.

### CROSS REFERENCE TO RELATED APPLICATION

This application claims the benefit of 63/609,959, filed Dec. 14, 2023, the disclosure of which is incorporated by reference herein in its entirety.

### BACKGROUND

Hearing devices that are disposed in an ear of a wearer or inserted into an opening of an ear canal of the wearer typically include a housing or shell with electronic components such as a receiver (i.e., speaker) disposed within the housing. The receiver is adapted to provide acoustic information in the form of acoustic energy to the wearer's ear canal from a controller either disposed within the housing of the hearing device or connected to the hearing device by a wired or wireless connection. This acoustic information can include music or speech from a recording or other source. In hearing devices such as hearing assistance devices, the acoustic information provided to the wearer can include ambient sounds such as speech from a person or persons that are speaking in proximity to the wearer. Such speech can be amplified so that the wearer can better hear the speaker.

Hearing assistance devices, such as hearing aids, can be used to assist wearers suffering hearing loss by amplifying sounds into one or both ear canals. Such devices typically include hearing assistance components such as a microphone for receiving ambient sound, an amplifier for amplifying the microphone signal in a manner that depends upon the frequency and amplitude of the microphone signal, a speaker or receiver for converting the amplified microphone signal to sound for the wearer, and a battery for powering the components.

In certain types of hearing aids, the hearing assistance components are enclosed by a housing that is designed to be worn in the ear for both aesthetic and functional reasons.

### SUMMARY

In general, the present disclosure provides various embodiments of a hearing device system. The system can include first and second hearing devices each configured to be disposed in an ear of a wearer. Each of the first and second hearing devices can include a microphone configured to sense acoustic waves from an environment of the wearer and convert such waves to a first audio signal and a second audio signal respectively. A controller of the system can be configured to provide a receiver signal to a receiver that is operatively coupled to one or both of the first and second hearing devices, where the received signal is based on at least one of the first audio signal or second audio signal. The controller can further be configured to modify the receiver signal based on a difference between a first signal to noise ratio of the first audio signal and a second signal to noise ratio of the second audio signal. In one or more embodiments, the controller can also be configured to determine a preferred ear of the wearer based at least in part on which ear receives the better signal to noise ratio, movement of a head or body of the wearer relative to which ear receives the better signal to noise ratio, or eye movement of the wearer relative to movement of the head or body.

In one aspect, the present disclosure provides a hearing device system that includes a first hearing device configured to be disposed on or in a first ear of a wearer and including a microphone that is configured to sense acoustic waves from an environment of the wearer and convert the sensed acoustic waves to a first audio signal; a second hearing device configured to be disposed on or in a second ear of the wearer and including a microphone that is configured to sense acoustic waves from the environment of the wearer and convert the sensed acoustic waves to a second audio signal; and a receiver operatively coupled to one or both of the first hearing device and the second hearing device. The receiver is configured to be in fluid communication with the first ear or the second ear, and output acoustic energy based on a receiver signal. The system further includes a controller configured to provide the receiver signal to the receiver based on at least one of the first audio signal or second audio signal, determine a first signal to noise ratio of the first audio signal, and determine a second signal to noise ratio of the second audio signal. The controller is further configured to compare the first signal to noise ratio and the second signal to noise ratio, and modify the receiver signal based on a difference between the first signal to noise ratio and the second signal to noise ratio.

In another aspect, the present disclosure provides a hearing device system that includes a first hearing device configured to be disposed on or in a first ear of a wearer. The first hearing device includes a first microphone configured to sense acoustic waves from an environment of the wearer and convert the sensed acoustic waves to a first audio signal, and a first receiver configured to provide acoustic energy to the first ear based on a first receiver signal. The system further includes a second hearing device configured to be disposed on or in a second ear of the wearer. The second hearing device includes a second microphone configured to sense acoustic waves from the environment and convert the sensed acoustic waves to a second audio signal, and a second receiver configured to provide acoustic energy to the second ear based on a second receiver signal. The system further includes a controller having one or more processors. The controller is operatively coupled to the first microphone, the second microphone, the first receiver, and the second receiver. Further, the controller is configured to provide the first receiver signal to the first receiver and the second receiver signal to the second receiver, determine a first signal to noise ratio of the first audio signal, and determine a second signal to noise ratio of the second audio signal. The controller is further configured to compare the first signal to noise ratio and the second signal to noise ratio, and modify at least one of the first receiver signal or the second receiver signal based on a difference between the first signal to noise ratio and the second signal to noise ratio.

In another aspect, the present disclosure provides a hearing device system that includes a first hearing device configured to be disposed on or in a first ear of a wearer and having a microphone that is configured to sense acoustic waves from an environment of the wearer and convert the sensed acoustic waves to a first audio signal; a second hearing device configured to be disposed on or in a second ear of the wearer and having a microphone that is configured to sense acoustic waves from the environment and convert the sensed acoustic waves to a second audio signal; and a movement sensor configured to sense movement of a head of the wearer and provide a movement signal based on the sensed movement. The system further includes a receiver operatively coupled to one or both of the first hearing device and the second hearing device. The receiver is configured to be in fluid communication with the first ear or the second ear, and output acoustic energy based on a receiver signal. The system further includes a controller configured to receive the movement signal; provide the receiver signal to the receiver based on the movement signal and at least one of the first audio signal or second audio signal; and determine a first signal to noise ratio of the first audio signal. The system is further configured to determine a second signal to noise ratio of the second audio signal, compare the first signal to noise ratio and the second signal to noise ratio, and modify the receiver signal based on the movement signal and a difference between the first signal to noise ratio and the second signal to noise ratio.

In another aspect, the present disclosure provides a method that includes providing a receiver signal to a receiver of a hearing device system based on at least one of a first audio signal or second audio signal, where the first audio signal is converted by a microphone of a first hearing device from acoustic waves from an environment of a wearer sensed by the microphone. The second audio signal is converted by a microphone of a second hearing device from acoustic waves from the environment of the wearer sensed by the microphone. Further, the first hearing device is configured to be disposed on or in a first ear of the wearer and the second hearing device is configured to be disposed on or in a second ear of the wearer. The method further includes determining a first signal to noise ratio of the first audio signal, determining a second signal to noise ratio of the second audio signal, comparing the first signal to noise ratio and the second signal to noise ratio, and modifying the receiver signal based on a difference between the first signal to noise ratio and the second signal to noise ratio.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements can be present. The term “consisting essentially of” means including any elements listed after the phrase and is limited to other elements that do not interfere with or contribute to the activity or action specified in the disclosure for the listed elements. Thus, the phrase “consisting essentially of” indicates that the listed elements are required or mandatory, but that other elements are optional and can or cannot be present depending upon whether or not they materially affect the activity or action of the listed elements.

The words “preferred” and “preferably” refer to embodiments of the disclosure that can afford certain benefits, under certain circumstances; however, other embodiments can also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example can be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as can be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of a hearing device system disposed on or proximate to the head of a wearer.

FIG. 2 is a schematic diagram of the hearing device system of FIG. 1.

FIG. 3 is a schematic diagram of one embodiment of a first hearing device of the hearing device system of FIGS. 1-2.

FIG. 4 is a schematic diagram of one embodiment of a second hearing device of the hearing device system of FIGS. 1-2.

FIG. 5 is a schematic diagram of the head of the wearer in relation to an acoustic source, where a frontal plane of the head is orthogonal to an axis that extends between the head of the wearer and an acoustic source.

FIG. 6 is a schematic diagram of the head of the wearer in relation to an acoustic source, where the head has moved from a position shown in FIG. 5 such that an angle is formed between the median plane and the axis that extends between the head of the wearer and the acoustic source.

FIG. 7 is a flowchart of one embodiment of a method that can be utilized with the hearing device system of FIGS. 1-2.

FIG. 8 is a flowchart of another embodiment of a method that can be utilized with the hearing device system of FIGS. 1-2.

### DETAILED DESCRIPTION

In general, the present disclosure provides various embodiments of a hearing device system. The system can include first and second hearing devices each configured to be disposed in an ear of a wearer. Each of the first and second hearing devices can include a microphone configured to sense acoustic waves from an environment of the wearer and convert such waves to a first audio signal and a second audio signal respectively. A controller of the system can be configured to provide a receiver signal to a receiver that is operatively coupled to one or both of the first and second hearing devices, where the receiver signal is based on at least one of the first audio signal or second audio signal. The controller can further be configured to modify the receiver signal based on a difference between a first signal to noise ratio of the first audio signal and a second signal to noise ratio of the second audio signal. In one or more embodiments, the controller can also be configured to determine a preferred ear of the wearer based at least in part on which ear receives the better signal to noise ratio, movement of a head or body of the wearer relative to which ear receives the better signal to noise ratio, or eye movement of the wearer relative to movement of the head or body.

When listening and turning an ear towards an acoustic source that can be difficult to hear in a setting that includes ambient noise, we naturally listen through our “better ear” (i.e., the ear that receives the best signal to noise ratio (SNR) from the acoustic source, referred to herein as the preferred ear) and sometimes ignore acoustic waves arriving at the other ear (a strategy referred to as “better ear listening”). This instinctive head turn brings the preferred ear closer to the acoustic source and moves the non-preferred ear further into an acoustic shadow of the head, thereby increasing the SNR differential between the ears. Such head turn is often exhibited in reverberant and/or noisy environments such as noisy social or work settings as such head turn can improve sensing of acoustic waves from the acoustic source. In typically noisy and reverberant social settings such as restaurants, this listening strategy has been shown to improve SNR by around 2 dB. The improvement can be much greater in less noisy and reverberant environments, i.e., up to 16 dB for normally-hearing individuals in an anechoic environment when the acoustic source is directly in front of the individual, and noise is directed from behind the individual.

Normal-hearing individuals can benefit from the additional information contained in the signal arriving at a non-preferred ear (the one acoustically penalized) in that comparing received information between the ears enables them to further reject the noise. This benefit is called “binaural unmasking.” For certain individuals, the signal from the non-preferred ear can be detrimental to target-signal accessibility (e.g., speech intelligibility) or identification in general because it interferes with the better-ear signal. This detriment is referred to either as “binaural interference” or “contralateral interference.” Up to 20% of the population suffer from contralateral interference. These individuals find it much harder to ignore the signal arriving at the non-preferred ear, such that its noisier signal interferes with their perception of the preferred-ear signal, thereby reducing speech intelligibility in noise, for instance. In such cases, the instinctive head turn will not necessarily provide much benefit and could potentially make speech intelligibility worse unless the noisier signal from the non-preferred ear is altered in some way.

For listeners that have not been diagnosed with contralateral interference, prolonged exposure to the mostly useless signal at the non-preferred ear may require increased effort to ignore this signal over time. As a result, irrespective of a contralateral interference diagnosis, there may be a comfort/effort-related benefit to assisting better-ear listening.

Contralateral interference is typically assessed by comparing monaural speech intelligibility in noise to binaural performance, in various spatial configurations, and is more likely to operate from the poorer-performing ear to the better-performing ear, especially when hearing loss is asymmetric. However, contralateral interference is rarely measured by audiologists. Most often, it is investigated only when the wearer rejects a hearing device fitted to the most impaired ear and reports greater difficulties in listening to speech in noise with two hearing devices as opposed to a single device. Yet, there may still be less noisy acoustic situations where such a wearer would benefit from wearing the second hearing device. Thus, assisted better-ear listening has the potential to significantly reduce the rejection rate of a second hearing device.

Techniques audiologists can use to identify whether a wearer suffers from contralateral interference typically involve presenting speech mixed with noise in a first ear and presenting either the same noise or silence in the second ear. When binaural unmasking works, presenting the same noise to the second ear helps the wearer perceptually separate speech and noise streams such that speech intelligibility is improved. When contralateral interference occurs, speech intelligibility worsens. Contralateral interference is more often considered in cochlear implant users for whom any asymmetry in dead cochlear regions and implant insertion depth can make interference worse. Given that contralateral interference can stem from an age-related impairment of the more central, binaural processes that normally combine information arriving at both ears, the proportion of the hearing device wearers that could benefit from assisted better-ear listening may be much larger than currently believed.

It may be that certain head-turn behaviors in noise are correlated with the presence of contralateral interference. Analysis of patterns of head turns, potentially assisted by machine learning algorithms, may be useful in the detection of good candidates for assisting better-ear listening. Combined with the severity of deafness and noise level estimation, such statistics may be employed to automatically enable assisted better-ear listening in these patients.

One or more embodiments of hearing device systems described herein can utilize techniques that determine the preferred ear of a wearer. For example, a hearing device system can include a controller that can be configured to determine a differential between a signal to noise ratio determined by a first hearing device disposed in or proximate to a first ear and a signal to noise ratio determined by a second hearing device disposed in or proximate to a second ear. An ear exhibiting the greatest signal to noise ratio can be identified as the preferred ear. Various embodiments of hearing device systems described herein can utilize detection of the preferred ear to improve listening.

A receiver signal provided to a receiver or speaker of the system can be modified to assist the wearer in better detecting and understanding acoustic information from the acoustic source. Such modifications to the receiver signal can include increasing gain of the receiver signal to the identified preferred ear or processing the receiver signal to provide more comfort to the wearer or clarity of the signal provided to the preferred ear.

Further, the receiver signal can be modified to reduce gain of the receiver signal provided to the non-preferred ear, process such receiver signal to improve comfort to this ear, or provide the signal provided by the hearing device of the preferred ear to the non-preferred ear with optional head-related transfer function correction to restore binaural cues to such ear. If the wearer of the hearing device system has been diagnosed as suffering from contralateral interference, such wearer can benefit from a reduction in gain of the receiver signal provided to the non-preferred ear, regardless of whether the wearer uses head orientation to improve the signal to noise ratio at their preferred ear. This benefit will likely increase as the background noise level increases, such that a reduction of the signal provided to the non-preferred ear can be made dependent on the noise level alone.

In one or more embodiments, the hearing device system can further be configured to detect when an acoustic source such as a target talker is not directly in front of the wearer's head. For instance, beamforming with two or more microphones of the system can be combined with signal analysis to establish both whether a signal contains speech information and the direction from which such a signal arrives at the ears. Furthermore, one or more techniques can improve the assessment of the situation and confirm that it is conducive to assisting listening through the preferred ear.

In situations where several talkers of interest exist, the hearing device system may use information arriving at one or more microphones of the system to track where a given talker starts talking.

In general, better-ear listening through improving speech intelligibility may reduce the listening effort exerted by the wearer to understand a conversation, thereby enabling the wearer to hear more effectively in noisy environments. This improved hearing in social settings may also improve confidence and, therefore, overall quality of life.

Embodiments of the disclosure are defined in the claims; however, herein there is provided a non-exhaustive listing of non-limiting examples. Any one or more of the features of these examples may be combined with any one or more features of another example, embodiment, or aspect described herein.

Example Ex1. A hearing device system that includes a first hearing device configured to be disposed on or in a first ear of a wearer and including a microphone that is configured to sense acoustic waves from an environment of the wearer and convert the sensed acoustic waves to a first audio signal; a second hearing device configured to be disposed on or in a second ear of the wearer and including a microphone that is configured to sense acoustic waves from the environment of the wearer and convert the sensed acoustic waves to a second audio signal; and a receiver operatively coupled to one or both of the first hearing device and the second hearing device. The receiver is configured to be in fluid communication with the first ear or the second ear, and output acoustic energy based on a receiver signal. The system further includes a controller configured to provide the receiver signal to the receiver based on at least one of the first audio signal or second audio signal, determine a first signal to noise ratio of the first audio signal, and determine a second signal to noise ratio of the second audio signal. The controller is further configured to compare the first signal to noise ratio and the second signal to noise ratio, and modify the receiver signal based on a difference between the first signal to noise ratio and the second signal to noise ratio.

Example Ex2. The system of Ex1, where to modify the receiver signal the controller is further configured to modify the receiver signal if the difference between the first signal to noise ratio and the second signal to noise ratio is greater than a signal to noise ratio difference threshold.

Example Ex3. The system of Ex1, where to modify the receiver signal the controller is further configured to increase a gain in the receiver signal of either the first audio signal or second audio signal having the greatest signal to noise ratio.

Example Ex4. The system of Ex1, where to modify the receiver signal the controller is further configured to decrease a gain in the receiver signal of either the first audio signal or second audio signal having the least signal to noise ratio.

Example Ex5. The system of Ex1, where to modify the receiver signal the controller is further configured to increase clarity in the receiver signal of either the first audio signal or second audio signal having the greatest signal to noise ratio.

Example Ex6. The system of Ex1, where to modify the receiver signal the controller is further configured to increase comfort in the receiver signal of either the first audio signal or second audio signal having the greatest signal to noise ratio.

Example Ex7. The system of Ex1, where to modify the receiver signal the controller is further configured to provide in the receiver signal either the first audio signal or second audio signal having the greatest signal to noise ratio to each of the first ear and second ear.

Example Ex8. The system of Ex1, where the controller is further configured to determine a preferred ear of the wearer.

Example Ex9. The system of Ex8, where to determine the preferred ear of the wearer the controller is further configured to identify which of the first audio signal or second audio signal has the greatest signal to noise ratio.

Example Ex10. The system of Ex8, where at least one of the first hearing device or second hearing device further includes an inertial measurement unit (IMU) operatively connected to the controller and configured to detect motion of a head of the wearer and provide a movement signal to the controller, where to determine the preferred ear of the wearer the controller is further configured to determine an angle between a median plane of the wearer and an axis that extends between the head of the wearer and an acoustic source relative to either a first ear side of the head or a second ear side of the head.

Example Ex11. The system of Ex8, further including an eye sensor operatively connected to the controller, where the eye sensor is configured to detect eye movement of at least one eye of the wearer and provide an eye movement signal to the controller, where to determine the preferred ear of the wearer the controller is further configured to determine motion of at least one eye of the wearer in relation to motion of a head of the wearer.

Example Ex12. The system of any one of Ex1-Ex11, where the controller is further configured to provide binaural localization cues to the wearer.

Example Ex13. The system of Ex12, where the controller is further configured to analyze the first audio signal and the second audio signal to determine a position of an acoustic source relative to the median plane of the wearer.

Example, Ex14. A hearing device system that includes a first hearing device configured to be disposed on or in a first ear of a wearer. The first hearing device includes a first microphone configured to sense acoustic waves from an environment of the wearer and convert the sensed acoustic waves to a first audio signal, and a first receiver configured to provide acoustic energy to the first ear based on a first receiver signal. The system further includes a second hearing device configured to be disposed on or in a second ear of the wearer. The second hearing device includes a second microphone configured to sense acoustic waves from the environment and convert the sensed acoustic waves to a second audio signal, and a second receiver configured to provide acoustic energy to the second ear based on a second receiver signal. The system further includes a controller having one or more processors. The controller is operatively coupled to the first microphone, the second microphone, the first receiver, and the second receiver. Further, the controller is configured to provide the first receiver signal to the first receiver and the second receiver signal to the second receiver, determine a first signal to noise ratio of the first audio signal, and determine a second signal to noise ratio of the second audio signal. The controller is further configured to compare the first signal to noise ratio and the second signal to noise ratio, and modify at least one of the first receiver signal or the second receiver signal based on a difference between the first signal to noise ratio and the second signal to noise ratio.

Example Ex15. The system of Ex14, where to modify at least one of the first receiver signal or the second receiver signal the controller is further configured to modify at least one of the first receiver signal or the second receiver signal if the difference between the first signal to noise ratio and the second signal to noise ratio is greater than a signal to noise ratio difference threshold.

Example Ex16. The system of Ex14, where to modify at least one of the first receiver signal or the second receiver signal the controller is further configured to increase a gain in at least one of the first receiver signal or the second receiver signal of either the first audio signal or second audio signal having the greatest signal to noise ratio.

Example Ex17. The system of Ex14, where to modify at least one of the first receiver signal or the second receiver signal the controller is further configured to decrease a gain in at least one of first receiver signal or the second receiver signal of either the first audio signal or second audio signal having the least signal to noise ratio.

Example Ex18. The system of Ex14, where to modify at least one of the first receiver signal or the second receiver signal the controller is further configured to increase clarity in at least one of the first receiver signal or the second receiver signal of either the first audio signal or second audio signal having the greatest signal to noise ratio.

Example Ex19. The system of Ex14, where to modify at least one of the first receiver signal or the second receiver signal the controller is further configured to increase comfort in at least one of the first receiver signal or the second receiver signal of either the first audio signal or second audio signal having the greatest signal to noise ratio.

Example Ex20. The system of Ex14, where to modify at least one of the first receiver signal or the second receiver signal the controller is further configured to provide in each of the first receiver signal and the second receiver signal either the first audio signal or second audio signal having the greatest signal to noise ratio to each of the first ear and second ear.

Example Ex21. The system of Ex14, where the controller is further configured to determine a preferred ear of the wearer.

Example Ex22. The system of Ex21, where to determine the preferred ear of the wearer the controller is further configured to identify which of the first audio signal or second audio signal has the greatest signal to noise ratio.

Example Ex23. The system of Ex21, where at least one of the first hearing device or second hearing device further includes an inertial measurement unit (IMU) operatively connected to the controller and configured to detect motion of a head of the wearer and provide a movement signal to the controller, where to determine the preferred ear of the wearer the controller is further configured to determine an angle between a median plane of the wearer and an axis that extends between the head of the wearer and an acoustic source relative to either a first ear side of the head or a second ear side of the head.

Example Ex24. The system of Ex21, further including an eye sensor operatively connected to the controller, where the eye sensor is configured to detect eye movement of at least one eye of the wearer and provide an eye movement signal to the controller, where to determine the preferred ear of the wearer the controller is further configured to determine motion of at least one eye of the wearer in relation to motion of a head of the wearer.

Example Ex25. The system of any one of Ex14-Ex24, where the controller is further configured to provide binaural localization cues to the wearer.

Example Ex26. The system of Ex25, where the controller is further configured to analyze the first audio signal and the second audio signal to determine a position of an acoustic source relative to the median plane of the wearer.

Example Ex 27. A hearing device system that includes a first hearing device configured to be disposed on or in a first ear of a wearer and having a microphone that is configured to sense acoustic waves from an environment of the wearer and convert the sensed acoustic waves to a first audio signal; a second hearing device configured to be disposed on or in a second ear of the wearer and having a microphone that is configured to sense acoustic waves from the environment and convert the sensed acoustic waves to a second audio signal; and a movement sensor configured to sense movement of a head of the wearer and provide a movement signal based on the sensed movement. The system further includes a receiver operatively coupled to one or both of the first hearing device and the second hearing device. The receiver is configured to be in fluid communication with the first ear or the second ear, and output acoustic energy based on a receiver signal. The system further includes a controller configured to receive the movement signal; provide the receiver signal to the receiver based on the movement signal and at least one of the first audio signal or second audio signal; and determine a first signal to noise ratio of the first audio signal. The system is further configured to determine a second signal to noise ratio of the second audio signal, compare the first signal to noise ratio and the second signal to noise ratio, and modify the receiver signal based on the movement signal and a difference between the first signal to noise ratio and the second signal to noise ratio.

Example Ex28. The system of Ex27, where the controller is further configured to determine a preferred ear of the wearer based on the movement signal.

Example Ex29. The system of Ex27, where the movement sensor includes an inertial measurement unit (IMU).

Example Ex30. The system of Ex29, further including an eye sensor operatively connected to the controller, where the eye sensor is configured to detect eye movement of at least one eye of the wearer and provide an eye movement signal, where to modify the receiver signal the controller is further configured to modify the receiver signal based on the movement signal, the eye movement signal, and a difference between the first signal to noise ratio and the second signal to noise ratio.

Example Ex31. The system of any one of Ex27-Ex30, where the controller is further configured to provide binaural localization cues to the wearer.

Example Ex32. The system of Ex31, where the controller is further configured to analyze the movement signal, the first audio signal, and the second audio signal to determine a position of an acoustic source relative to a median plane of the wearer.

Example Ex33. A method that includes providing a receiver signal to a receiver of a hearing device system based on at least one of a first audio signal or second audio signal, where the first audio signal is converted by a microphone of a first hearing device from acoustic waves from an environment of a wearer sensed by the microphone. The second audio signal is converted by a microphone of a second hearing device from acoustic waves from the environment of the wearer sensed by the microphone. Further, the first hearing device is configured to be disposed on or in a first ear of the wearer and the second hearing device is configured to be disposed on or in a second ear of the wearer. The method further includes determining a first signal to noise ratio of the first audio signal, determining a second signal to noise ratio of the second audio signal, comparing the first signal to noise ratio and the second signal to noise ratio, and modifying the receiver signal based on a difference between the first signal to noise ratio and the second signal to noise ratio.

Example Ex34. The method of Ex33, where modifying the receiver signal includes modifying the receiver signal if the difference between the first signal to noise ratio and the second signal to noise ratio is greater than a signal to noise ratio difference threshold.

Example Ex35. The method of Ex33, where modifying the receiver signal includes increasing a gain in the receiver signal of either the first audio signal or second audio signal having the greatest signal to noise ratio.

Example Ex36. The method of Ex33, where modifying the receiver signal includes decreasing a gain in the receiver signal of either the first audio signal or second audio signal having the least signal to noise ratio.

Example Ex37. The method of Ex33, where modifying the receiver signal includes increasing clarity in the receiver signal of either the first audio signal or second audio signal having the greatest signal to noise ratio.

Example Ex38. The method of Ex33, where modifying the receiver signal includes increasing comfort in the audio signal of either the first audio signal or second audio signal having the greatest signal to noise ratio.

Example Ex39. The method of Ex33, where modifying the receiver signal includes providing in the receiver signal either the first audio signal or second audio signal having the greatest signal to noise ratio to each of the first ear and second ear.

Example Ex40. The method of Ex33, further including determining a preferred ear of the wearer.

Example Ex41. The method of Ex40, where determining the preferred ear of the wearer includes identifying which of the first audio signal or second audio signal has the greatest signal to noise ratio.

Example Ex42. The method of Ex40, where determining the preferred ear of the wearer includes detecting motion of a head of the wearer, and determining an angle between a median plane of the wearer and an axis that extends between the head of the wearer and an acoustic source relative to either a first ear side of the head or a second ear side of the head.

Example Ex43. The method of Ex40, where determining the preferred ear of the wearer includes detecting eye movement of one or both eyes of the wearer, and determining an angle between a direction that the wearer is looking and a median plane of the wearer.

Example Ex44. The method of any one of Ex33-Ex43, further including providing binaural localization cues to the wearer.

Example Ex45. The method of Ex44, further including analyzing the first audio signal and the second audio signal to determine a position of an acoustic source relative to the median plane of the wearer.

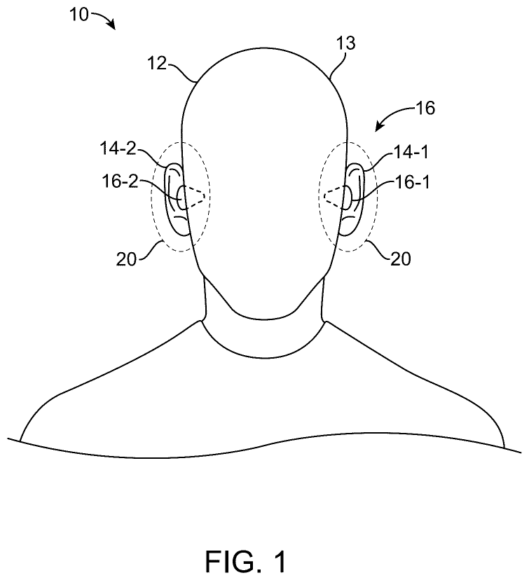

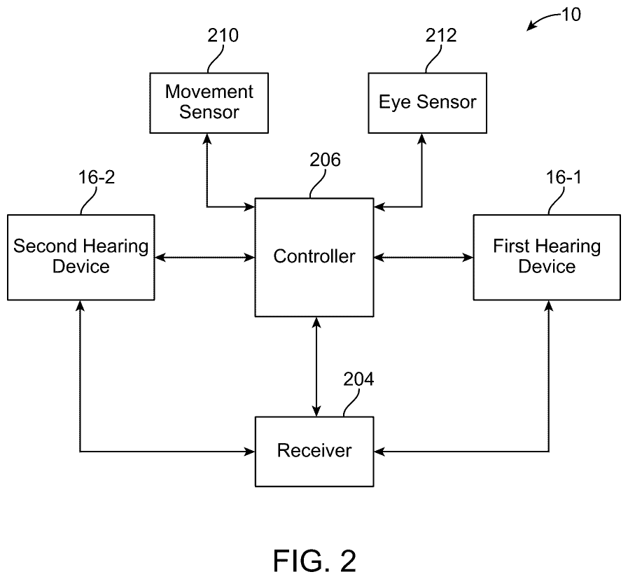

FIGS. 1-2 are various views of one embodiment of a hearing device system 10 disposed on or proximate to a wearer 12 and includes a first hearing device 16-1 and a second hearing device 16-2 (collectively referred to herein as hearing device or hearing devices 16). The first hearing device 16-1 is configured to be disposed on or in a first ear 14-1 of the wearer 12, and the second hearing device 16-2 is configured to be disposed on or in a second ear 14-2 of the wearer (the first and second ears are collectively referred to herein as ear or ears 14).

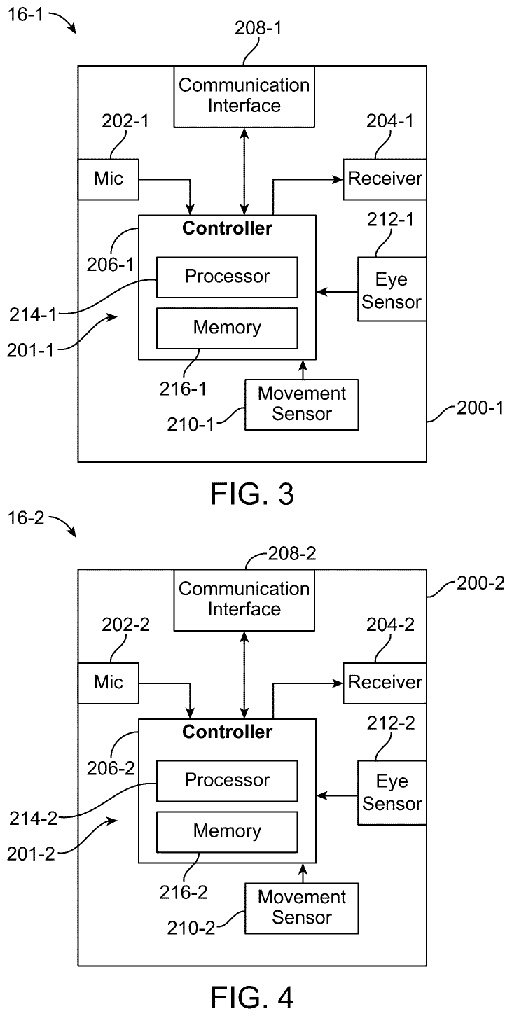

Each hearing device 16 can include any suitable components or circuitry. As shown in FIG. 3, which is a diagrammatic view of the first hearing device 16-1, such device can include a microphone 202-1 that is configured to sense acoustic waves from an environment of the wearer 12 and convert the sensed acoustic waves to a first audio signal. Further, as shown in FIG. 4, the second hearing device 16-2 can also include a microphone 202-2 that is configured to sense acoustic waves from the environment of the wearer 12 and convert the sensed acoustic waves to a second audio signal. The microphones 202-1 and 202-2 are collectively referred to herein as microphone or microphones 202.

As shown in FIG. 2, the system 10 can further include a receiver 204 operatively coupled to one or both of the first hearing device 16-1 and the second hearing device 16-2. The receiver 204 can be configured to be in fluid communication with at least one of the first ear 14-1 or the second ear 14-2, and output acoustic pressure based on a receiver signal. The system 10 can also include a controller 206 that is configured to provide the receiver signal to the receiver 204 based on at least one of the first audio signal or second audio signal, determine a first signal to noise ratio of the first audio signal (SNR1), and determine a second signal to noise ratio of the second audio signal (SNR2). The controller 206 can further be configured to compare SNR1 and SNR2 and modify the receiver signal based on an absolute value of a difference (ΔSNR) between SNR1 and SNR2 (ΔSNR=|SNR1−SNR2|).

As illustrated, each hearing device 16 can be worn proximate, or adjacent to, the pinna or worn in one or both ears 14 of wearer 12. As illustrated, each hearing device 16 is positioned, at least partially, in each ear 14. In one or more embodiments, each hearing device 16 is positioned in a region or zone 20 around each ear 14. Various embodiments of hearing devices 16 of hearing device system 10 can also include sensors, such as a movement sensor or microphone, disposed outside such zone 20 or within the zone 20, or such sensors can be positioned on headbands going over the head, on neckbands behind the head, or on cords connected to other devices.

The hearing devices 16 can include any suitable device that can be utilized to provide acoustic energy to the wearer, e.g., a hearing assistance device, an earphone, or a headphone (e.g., earbud). Further, each hearing device 16 can include any suitable circuitry or components, e.g., a receiver, one or more sensors, such as a motion detector, a microphone, a heart rate sensor, or an electrophysiological sensor, etc., as is further described herein.

The hearing devices 16 can include at least one hearing assistance device. Any suitable hearing assistance device can be utilized, e.g., behind-the-ear (BTE), in-the-ear (ITE), in-the-canal (ITC), receiver-in-canal (RIC), completely-in-the-canal (CIC), or invisible-in-the-canal (IIC)-type hearing aids. It is understood that BTE type hearing assistance devices can include devices that reside substantially behind the ear or over the ear. Such devices can include hearing aids with receivers associated with the electronics portion of the device or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted, or occlusive fitted. The present subject matter can additionally be used in consumer electronic wearable audio devices having various functionalities. It is understood that other devices not expressly stated herein can also be used in conjunction with the present subject matter.

FIGS. 3 and 4 are diagrammatic views of the first hearing device 16-1 and the second hearing device 16-2 respectively. The first hearing device 16-1 can include one or more electronic components 201-1 disposed on or at least partially within a housing 200-1, and the second hearing device 16-2 can include one or more electronic components 201-2 disposed on or at least partially within a housing 200-2 (electronic components 201-1 and 201-2 are collectively referred to herein as electronic component or components 201, and housings 200-1 and 200-2 are collectively referred to herein as housing or housings 200). The electronic components 201 can be disposed in any suitable location or arrangement within the housing 200. In one or more embodiments, one or more of the electronic components 201 can be disposed at least partially within the housing 200, on the housing, or external to the housing.

The electronic components 201 can include any suitable circuits or devices, e.g., integrated circuits, power sources, microphones, receivers, etc. For example, in one or more embodiments, the components 201 include one or more of a controller 206, a microphone 202, a receiver (e.g., speaker) 204, a power source (Not shown), an antenna (e.g., a communication interface 208), or various other sensors (e.g., movement sensor, heart rate sensor, or electrophysiological sensor). The electronic component 201 can be electrically connected to the controller 206 using any suitable technique.

In the illustrated embodiment, the first hearing device 16-1 includes the microphone 202-1, a receiver 204-1, a controller 206-1, a communication interface 208-1, a movement sensor 210-1, and an eye sensor 212-1. Further, the second hearing device 16-2 includes the microphone 202-2, a receiver 204-2, a controller 206-2, a communication interface 208-2, a movement sensor 210-2, and an eye sensor 212-2.

Each microphone 202-1 and 202-2 can be electrically connected to the respective controller 206-1, 206-2 (collectively referred to herein as controller or controllers 206). Although each hearing device 16 includes one microphone 202-1, 202-2 respectively, the components 201 can include any suitable number of microphones. In one or more embodiments, a port or opening can be formed in the housing 200, and the microphone 202 can be disposed adjacent the port to receive audio information from the wearer's ambient acoustic environment. In one or more embodiments, the microphone 202 is configured to sense acoustic waves from the environment of the wearer 12 and convert the sensed acoustic waves to an audio signal.

Returning to FIG. 2, the receiver 204 (e.g., at least one of receiver 204-1 of the first hearing device 16-1 or receiver 204-2 of the second hearing device 16-2) can include any suitable receiver or speaker and can be electrically connected to the controller 206 (e.g., at least one of controller 206-1 of first hearing device 16-1 or controller 206-2 of the second hearing device 16-2) using any suitable technique. Further the receiver 204 can be in fluid communication with one or both ears 14. As used herein, the term “fluid communication” means that the receiver 204 is disposed such that it can send and receive acoustic information to and from at least one of the first ear 14-1 or second ear 14-2. The receiver 204 can also be referred to as a speaker. Further, the receiver 204 can be operatively coupled to one or both of the first hearing device 16-1 and the second hearing device 16-2. The receiver 204 can be in fluid communication with the first ear 14-1 and the second ear 14-2 using any suitable technique. The receiver 204 can further be configured to output acoustic energy based on a receiver signal provided by the controller 206 based on at least one of the first audio signal or second audio signal. In one or more embodiments, the receiver 204 is adapted to convert the receiver signal from the controller 206 to an acoustic output or sound that can be transmitted from at least one of the first hearing device 16-1 or the second hearing device 16-2 to the wearer 12. For example, in hearing applications, speaker 204 can be an amplified version of an audio or microphone signal received from one or both microphones 202.

The system 10 can include any suitable number of receivers 204 disposed in any suitable position or location relative to the wearer 12. The receiver 204 is operatively coupled to one or both of the first hearing device 16-1 and the second hearing device 16-2. In one or more embodiments, the receiver 204 can be disposed within a housing of a BTE device, and acoustic energy produced by the receiver can be directed to one or both ears 14 of the wearer 12 by a cable or tube that connects the BTE housing to an earpiece. In one or more embodiments, the receiver 204 can be disposed on or at least partially within either the first hearing device 16-1 or the second hearing device 16-2. In one or more embodiments, the receiver 204 can include a first receiver 204-1 disposed on or at least partially within the housing 200-1 of the first hearing device 16-1 and a second receiver 204-1 disposed on or at least partially within the housing 200-2 of the second hearing device 16-2 as shown in FIGS. 3 and 4.

The system 10 can include suitable number of controllers 206. Such controller 206 can be operably coupled to at least one of the first hearing device 16-1, the second hearing device 16-2, the receiver 204, the movement sensor 210, the eye sensor 212, or one or more additional devices or components.

The controller 206 can be disposed in any suitable position relative to the wearer 12. In one or more embodiments, the controller 206 can be disposed in an external device or system and operatively connected to at least one of the first hearing device 16-1, the second hearing device 16-2, the receiver 204, the movement sensor 210, the eye sensor 212, or other devices or components of the system 10 by a wired or wireless connection. In one or more embodiments, the controller 206 can be disposed on or at least partially within at least one of the housing 200-1 of the first hearing device 16-1 or the housing 200-2 of the second hearing device 16-2.

For example, as shown in FIGS. 3 and 4, the controller 206 includes the first controller 206-1 disposed on or at least partially within the housing 200-1 of the first hearing device 16-1 and the second controller 206-2 disposed on or at least partially within the housing 200-2 of the second hearing device 16-2. In the illustrated embodiments, the first controller 206-1 includes a processor 214-1 and memory 216-1, and the second controller 206-2 includes a processor 214-2 and memory 216-2.

In general, the controller 206 can include a digital signal processor (DSP), microprocessor, microcontroller, other digital logic, or combinations of these. Processing can be done by a single processor or can be distributed over different devices. For example, the processing of signals can be performed using controller 206 or over different devices. Processing can be done in the digital domain, the analog domain, or combinations thereof. In some embodiments, processing can be done using subband processing techniques. Processing can be done using frequency domain or time domain approaches. Some processing can involve both frequency and time domain aspects. For brevity, in some examples, drawings can omit certain blocks that perform frequency synthesis, frequency analysis, analog-to-digital conversion, digital-to-analog conversion, amplification, buffering, and certain types of filtering and processing. In one or more embodiments, processors 214-1 and 214-2 or other processing devices execute instructions to perform a number of signal processing tasks. Such embodiments can include analog components in communication with processors 214-1 and 214-2 to perform signal processing tasks, such as sound reception by microphones 202 or playing of sound using receiver 204.

The processor 214-1 and 214-2 (collectively referred to herein as processors 214) of the controllers 206-1 and 206-2 can include any one or more of a microprocessor, a microcontroller, a digital signal processor (DSP), an application specific integrated circuit (ASIC), a field-programmable gate array (FPGA), and/or equivalent discrete or integrated logic circuitry. In some examples, the processor can include multiple components, such as any combination of one or more microprocessors, one or more controllers, one or more DSPs, one or more ASICs, and/or one or more FPGAs, as well as other discrete or integrated logic circuitry. The functions attributed to the controller 206 or processor 214 herein can be embodied as software, firmware, hardware, or any combination thereof. While described herein as a processor-based system, an alternative controller can utilize other components such as relays and timers to achieve the desired results, either alone or in combination with a microprocessor-based system.

In one or more embodiments, the exemplary systems, methods, and interfaces can be implemented using one or more computer programs using a computing apparatus, which can include one or more processors and/or memory. Program code and/or logic described herein can be applied to input data/information to perform functionality described herein and generate desired output data/information. The output data/information can be applied as an input to one or more other devices and/or methods as described herein or as would be applied in a known fashion. In view of the above, it will be readily apparent that the controller functionality as described herein can be implemented in any manner known to one skilled in the art.

In general, the controller 206 can be configured to provide the receiver signal to the receiver 204 based on at least one of the first audio signal or second audio signal from the microphones 202 of the first and second hearing devices 16-1 and 16-2. Further, the controller 206 can be configured to determine the first signal to noise ratio (SNR1) of the first audio signal, determine the second signal to noise ratio (SNR2) of the second audio signal, and compare SNR1 and SNR2. Further, the controller 206 can be configured to modify the receiver signal based on a difference (ΔSNR) between SNR1 and SNR2.

The controller 206 can be configured to use any suitable technique to determine whether to modify the receiver signal. For example, the controller 206 can be configured to modify the receiver signal if the difference between SNR1 and SNR2 (i.e., ΔSNR=|SNR1−SNR2|) is greater than a signal to noise ratio difference threshold (SNRT). Any value of SNRT can be selected. In one or more embodiments, the SNRT can be at least 1 dB and no greater than 30 dB.

Further, the controller 206 can be configured to modify the receiver signal using any suitable technique. In one or more embodiments, the controller 206 can be configured to modify the receiver signal by increasing a gain in the receiver signal of either the first audio signal or the second audio signal having the greatest signal to noise ratio. For example, if the first audio signal from the microphone 202-1 of the first hearing device 16-1 has an SNR1 that is greater than SNR2 from the microphone 202-2 of the second hearing device 16-2, then a gain of the first audio signal can be increased in the receiver signal provided to at least one of the first ear 14-1 or second ear 14-2.

Further, for example, the controller 206 can be configured to modify the receiver signal by decreasing a gain in the receiver signal of either the first audio signal or second audio signal having the lowest or least signal to noise ratio. For example, if the first audio signal from the microphone 202-1 of the first hearing device 16-1 has an SNR1 that is greater than SNR2 of the second audio signal from the microphone 202-2 of the second hearing device 16-2, then a gain of the second audio signal can be decreased in the receiver signal provided to at least one of the first ear 14-1 or second ear 14-2.

In one or more embodiments, the controller 206 can be configured to modify the receiver signal by increasing clarity in the receiver signal of either the first audio signal or second audio signal having the greatest signal to noise ratio. As used herein, the term “clarity” means that a signal of interest (e.g., speech) produced by the receiver 204 is devoid of distortions. For example, if the first audio signal from the microphone 202-1 of the first hearing device 16-1 has an SNR1 that is greater than SNR2 of the second audio signal from the microphone 202-2 of the second hearing device 16-2, then clarity of the first audio signal can be increased in the receiver signal provided to at least one of the first ear 14-1 or second ear 14-2. Any suitable technique can be utilized to increase clarity of the first audio signal or second audio signal.

The controller 206 can also be configured to modify the receiver signal by increasing comfort in the receiver signal of either the first audio signal or second audio signal having the greatest signal to noise ratio. As used herein, the term “comfort” means that listening to a signal of interest is a comfortable experience or presents the least cognitive load on the listener. For example, if the first audio signal from the microphone 202-1 of the first hearing device 16-1 has an SNR1 that is greater than SNR2 from the microphone 202-2 of the second hearing device 16-2, then comfort of the first audio signal can be increased in the receiver signal directed to at least one of the first ear 14-1 or the second ear 14-2. Any suitable technique can be utilized to increase comfort of the first audio signal or second audio signal, e.g., compression, expansion, filtering, automatic gain leveling, etc.

The controller 206 can also be configured to modify the receiver signal by providing in the receiver signal either the first audio signal or second audio signal having the greatest signal to noise ratio to each of the first ear 14-1 and second ear 14-2. For example, if the first audio signal from the microphone 202-1 of the first hearing device 16-1 has an SNR1 that is greater than an SNR2 from the microphone 202-2 of the second hearing device 16-2, then the first audio signal can be provided in the receiver signal directed to each of the first ear 14-1 or second ear 14-2.

The controller 206 can also be configured to determine a preferred ear of the wearer using any suitable technique. For example, the controller 206 can be configured to determine the preferred ear by identifying which of the first audio signal or second audio signal has the greatest signal to noise ratio. As most wearers instinctively rotate their heads such that the preferred ear is directed toward the acoustic source, the signal to noise ratio of the audio signal provided by the microphone of the hearing device disposed in the ear that is directed toward the target would likely have the greatest signal to noise ratio. Such ear would then likely be considered the preferred ear.

Further, one or more additional sensors can be utilized to determine or confirm the preferred ear of the wearer 12. For example, the system 10 can include the movement sensor 210 that is operatively connected to the controller 206 as shown in FIG. 2. The system 10 can include any suitable number of movement sensors 210. In one or more embodiments, at least one of the first hearing device 16-1 or second hearing device 16-2 can include the movement sensor 210. For example, as shown in FIGS. 3 and 4, the movement sensor 210 can include a first movement sensor 210-1 of the first hearing device 16-1 and a second movement sensor 210-2 of the second hearing device 16-2. Any suitable movement sensor 210 can be utilized, e.g., an inertial measurement unit (IMU). The controller 206 can be configured to detect motion of the head of the wearer 12 utilizing the movement sensor 210 and using any suitable technique. In one or more embodiments, the movement sensor 210 can be configured to provide a head movement signal to the controller 206 using any suitable technique.

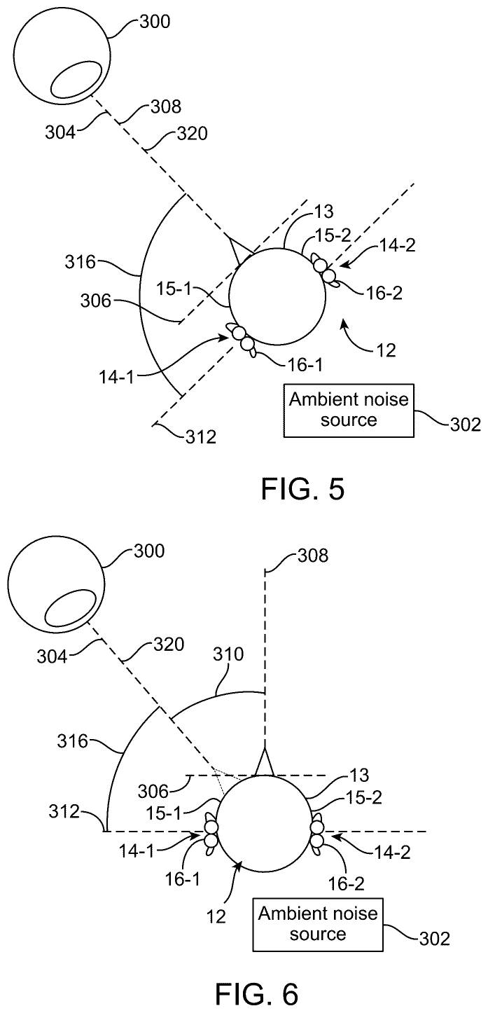

For example, FIG. 5 is a schematic diagram of the head 13 of the wearer 12 in relation to an acoustic source 300, where a frontal plane 306 of the head is substantially orthogonal to an axis 304 that extends between the head of the wearer and the acoustic source. As shown in FIG. 5, the wearer 12 is facing the acoustic source 300 such that a median plane 308 of the head 13 of the wearer 12 is directed to the acoustic source. As used herein, the term “median plane” refers to a plane 308 that is orthogonal to a line between the first ear 14-1 and the second ear 14-2 of the wearer (i.e., the interaural axis 312). In this orientation, the wearer 12 can be considered to be facing the acoustic source 300 such that an angle 310 (FIG. 6) between the median plane 308 and the axis 304 that extends between the head 13 of the wearer 12 and the acoustic source is equal to about 0 degrees. Further, an angle 316 between the interaural axis 312 and the axis 304 on either a first ear side 15-1 of the head 13 or a second ear side 15-2 of the head is equal to about 90 degrees. FIGS. 5-6 further illustrate an ambient noise source 302 that provides ambient noise that can make it challenging for the wearer 12 to hear the acoustic source 300 or understand acoustic information being transmitted by the source.

As shown in FIG. 6, the head 13 of the wearer 12 has rotated such that the angle 310 between the axis 304 and the median plane 308 of the head is greater than 0 degrees. Further, in this orientation, the angle 316 between the axis 304 and the interaural axis 312 on the first ear side 15-1 of the head 13 is less than 90 degrees, thereby indicating that the preferred ear of the wearer is the first ear 14-1 as the wearer has rotated the head such that the first ear is directed toward the acoustic source 300. In one or more embodiments, if the angle 316 between the axis 304 and the interaural axis 312 on the first ear side 15-1 of the head 13 is greater than 90 degrees, then the preferred ear of the wearer is the second ear 14-2 as the wearer has rotated the head 13 such that the second ear is directed toward the acoustic source 300. The controller 206 can, therefore, be configured to determine the preferred ear of the wearer 12 by determining the angle 316 between the interaural axis 312 and the axis 304 on the first ear side 15-1 of the head 13 (or second ear side 15-2 of the head). In one or more embodiments, the controller 206 can be configured to determine the preferred ear by determining the angle 310 between the median plane 308 of the wearer and the axis 304 that extends between the head 13 of the wearer and the acoustic source 300 relative to either the first ear side 15-1 of the head or the second ear side 15-2 of the head. In one or more embodiments, the controller 206 can be configured to determine the preferred ear of the wearer 12 by determining which ear is on the same side of the median plane 308 as the acoustic source 300. As shown in FIG. 6, the first ear 14-1 is on the same side of the median plane 308 as the acoustic source 300; therefore, the first ear is the preferred ear of the wearer 12.

In one or more embodiments, the controller 206 can be configured to determine the preferred ear of the wearer 12 based solely upon the head movement signal from the movement sensor 210 or in conjunction with the comparison between SNR1 and SNR2. In one or more embodiments, if the head movement signal is greater than a head movement threshold, then the receiver signal can be modified based upon the comparison of SNR1 and SNR2 and the head movement signal. Any suitable head movement threshold can be utilized, e.g., a head movement of at least 5 degrees and no greater than 30 degrees in a plane orthogonal to the median plane.

Further, in one or more embodiments the system 10 can include the eye sensor 212 (FIG. 2) that is operatively connected to the controller 206 using any suitable technique. The eye sensor 212 can include any suitable device or component that can detect eye movement of the wearer 12. Further, the eye sensor 212 can be disposed in any suitable location relative to the wearer 12. In one or more embodiments, the eye sensor 212 can be associated with at least one of the first hearing device 16-1 or second hearing device 16-2. The system 10 can include any suitable number of eye sensors 212. For example, as shown in FIG. 3, the eye sensor 212 includes a first eye sensor 212-1 of hearing device 16-1 operatively connected to controller 206-1 and a second eye sensor 212-2 of the second hearing device 16-2 operatively connected to controller 206-2.

The eye sensor or sensors 212 can be configured to detect eye movement of at least one eye of the wearer 12 and provide an eye movement signal to the controller 206 using any suitable technique. To determine the preferred ear 14 of the wearer 12, the controller 206 can be configured to determine motion of at least one eye of the wearer 12 relative to motion of the head 13 of the wearer 12 using any suitable technique. For example, the controller 206 can be configured to determine the angle 310 between the normal to the frontal plane 306 of the head 13 of the wearer 12 and a direction 320 that the eyes are looking as shown in FIG. 6. Such figure illustrates that when the wearer 12 rotates the head 13 such that the preferred ear (in this case first ear 14-1) is directed toward the acoustic source 300, one or both eyes of the wearer will continue to look toward the acoustic source to make eye contact with the target and/or to read lips and other cues to better understand speech coming from the acoustic source. As a result, one or both of the eyes of the wearer 12 will look in the direction 320, which is parallel to or along the axis 304 that extends between the head 13 of the wearer and the acoustic source 300. The angle 310 between the axis 304, which is the direction the wearer 12 is looking, and the median plane 308 of the wearer 12 can be determined by the controller 206 utilizing the eye movement signal provided by the eye sensor 212. In one or more embodiments, if the eye movement signal is greater than an eye movement threshold, then the receiver signal can be modified using any suitable technique. The eye movement threshold can be any value, e.g., at least 5 degrees and no greater than 30 degrees in the median plane.

In one or more embodiments, the controller 206 can be configured to determine the preferred ear of the wearer 12 based solely upon the eye movement signal from the eye sensor 212, with the comparison between the first signal to noise ratio and the second signal to noise ratio, with the head movement signal, or with the comparison between the first signal to noise ratio and the second signal to noise ratio and the head movement signal. In one or more embodiments, the preferred ear of the wearer 12 can be in part determined by the controller 206 by comparing the motion of at least one eye of the wearer as detected by the eye sensor 212 relative to motion of the head 13 of the wearer (e.g., position of at least one eye within the head). For example, because the wearer 12 can rotate the head 13 in one direction such that the preferred ear is most closely aligned along the axis 304 that extends between the head and the acoustic source 300, then one or both eyes of the wearer will rotate in the opposite direction to maintain line of sight to the source. If the eyes rotate in a direction opposite a direction of rotation of the head 13, then the controller 206 can be configured to determine that the ear most closely aligned to the target source 300 is the preferred ear.

The controller 206 can further be configured to provide additional signals or cues to the wearer 12 based upon at least one of the first or second audio signals provided by the first and second microphones 202-1, 202-2 respectively. For example, the controller 206 can be configured to provide one or more binaural localization cues to the wearer 12 using any suitable technique. As used herein, the term “binaural localization cues” means an interaural level difference and interaural time delay for sound coming from a given source, resulting from that sound source not being directly in front of the head. In one or more embodiments, such binaural localization cues can be provided by configuring the controller 206 to analyze the first audio signal and the second audio signal to determine a position of the acoustic source 300 relative to the median plane 308 of the wearer 12. A head-related transfer function, for instance, can be used to restore binaural cues between receiver signals when the receiver signals have been altered by the controller 206 in any way mentioned above.

As mentioned herein, the hearing device system 10 can include any suitable circuitry or components. For example, a power source (not shown) can be electrically connected to the controller 206 and can be adapted to provide electrical energy to the controller 206 and one or more of the other electronic components 201. Each hearing device 16-1 and 16-2 can include one or more power sources. The power source can include any suitable power source or power sources, e.g., a battery. In one or more embodiments, the power source can include a rechargeable battery. In one or more embodiments, the components 201 can include two or more power sources.

Hearing device 16 can be configured to communicate by wire or wirelessly with each other or other devices. Processors 214-1 and 214-2 can be configured to control communication to and from each hearing device 16-1 and 16-2 through communication interface 208-1 and 208-2 respectively (collectively communication interface 208). Communication interface 208 can be used to communicate information, for example, audio streaming data or control signals, to or from one or more other devices. Communication interface 208 can be contained in the housing 200 of the hearing device 16. In general, communication interface 208 is configured to communicate with a user-controlled device.

In one or more embodiments, communication interface 208 can include a transceiver. The transceiver can include a receiver portion that receives communication signals from an antenna structure, demodulates the communication signals, and transfers the signals to controller 206 for further processing. The transceiver can also include a transmitter portion that modulates output signals from controller 206 for transmission via the antenna structure. Electrical signals from microphone 202 and wireless communication signals received via communication interface 208 can be processed by controller 206 and converted to acoustic signals played to the user via receiver 204. In some embodiments, communication interface 208 can include a wired connection, such as an audio adapter or a wired data connection.

The antenna structure of communication interface 208 can include one or more antennas having any suitable configuration. For example, antenna configurations can vary and can be included within the housing or be external to the housing. Further, the antenna structure can be compatible with any suitable protocol or combination of protocols.

For example, at least one of the hearing devices 16 can be connected to one or more external devices using, e.g., Bluetooth®, Wi-Fi, magnetic induction, etc. In one or more embodiments, at least one hearing device 16 can be wirelessly connected to the internet using any suitable technique. Such connection can enable the hearing device 16 to access any suitable databases, including medical records databases, cloud computing databases, personal databases, or social networks.

In embodiments where hearing device 16 includes the second hearing device 16-2 disposed on an opposite side of the wearer's head 13, communication interface 208 can be utilized to communicate with a communication interface of the second hearing device. In one or more embodiments, a low-power link across the wearer's head 13 can be utilized to transmit electromagnetic signals between the first and second hearing devices 16-1 and 16-2. Sensor data from the one or more sensors can be coordinated between the two hearing devices 16.

One or more sensors of hearing device 16 can also be utilized to electrically connect to the wearer's body such that the body can be utilized as an antenna for transmitting information to and from the hearing device. Such sensors can be considered part of communication interface 208. One or more sensors can electrically connect hearing device 16 to one or more additional body-worn devices by sending electromagnetic signals between the devices through the body. For example, for hearing systems that include two hearing devices 16, one or more sensors can be utilized for communication between the hearing devices through the skull or head 13 or around the head of the wearer 12, i.e., ear-to-ear communications. Such communication can be utilized to send signals from one device to the other. For example, the wearer 12 can adjust a volume of an acoustic signal provided by the hearing devices by changing the volume on one device, which sends a control signal to the other device that adjusts its volume.

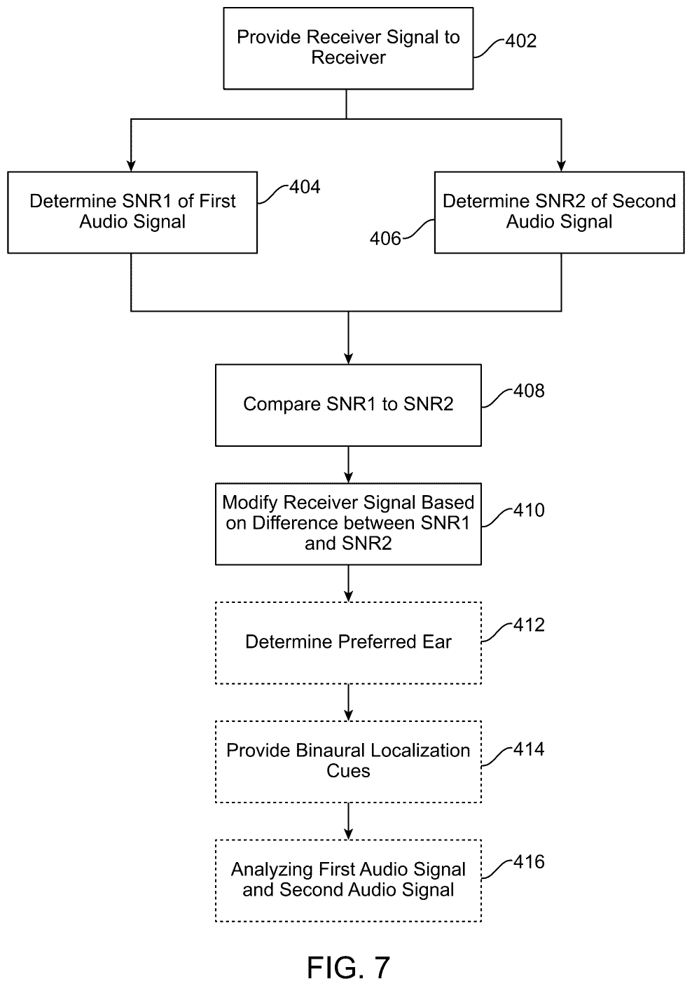

Any suitable technique can be utilized with the first and second hearing devices 16-1, 16-2 to provide an improved receiver signal to the wearer 12 by, e.g., determination of the preferred ear 14 of the wearer 12. For example, FIG. 7 is a flowchart of one embodiment of a method 400 of utilizing the hearing device system 10. Although described regarding the hearing device system 10 of FIGS. 1-4, the method 400 can be utilized with any suitable hearing device system. At 402, the receiver signal can be provided to the receiver 204 of the hearing device system 10 based on at least one of the first audio signal or the second audio signal. The first audio signal is converted by the microphone 202-1 of the first hearing device 16-1 from acoustic waves from the environment of the wearer 12 that are sensed by the microphone. Further, the second audio signal is converted by the microphone 202-2 of the second hearing device 16-2 from acoustic waves from the environment of the wearer 12 sensed by the microphone. The first hearing device 16-1 is configured to be disposed on or in the first ear 14-1 of the wearer 12, and the second hearing device 16-2 is configured to be disposed on or in the second ear 14-2 of the wearer.

A first signal to noise ratio (SNR1) of the first audio signal can be determined at 404 using any suitable technique. In one or more embodiments, the controller 206 is configured to determine SNR1. Further, the second signal to noise ratio (SNR2) of the second audio signal can be determined at 406 utilizing any suitable technique, e.g., the controller 206 can be configured to determine SNR2. At 408, SNR1 and the SNR2 can be compared using any suitable technique, e.g., utilizing the controller 206.

The receiver signal can be modified at 410 based on a difference between SNR1 and SNR2 using any suitable technique. For example, the receiver signal can be modified if the difference between SNR1 and the SNR2 is greater than a signal to noise ratio difference threshold (SNRT). Further, for example, a gain in the receiver signal of either the first audio signal or second audio signal having the greatest signal to noise ratio can be increased. Further, for example, the gain of either the first audio signal or the second audio signal having the least signal to noise ratio can be decreased. In addition, the receiver signal can be modified by increasing at least one of the clarity or comfort in the audio signal of either the first audio signal or second audio signal having the greatest signal to noise ratio. Further, the receiver signal can be modified by providing in the receiver signal directed to each of the first ear 14-1 and second ear 14-2 either the first audio signal or second audio signal having the greatest signal to noise ratio.

At 412, a preferred ear 14 of the wearer 12 can optionally be determined using any suitable technique described herein. For example, the preferred ear can be determined by identifying which of the first audio signal or second audio signal has the greatest signal to noise ratio. In one or more embodiments, the preferred ear 14 can be determined by detecting motion of the head 13 of the wearer 12, and determining the angle 316 between the axis 304 and the interaural axis 312 relative to either the first ear side 15-1 or the second ear sided 15-2 of the head. Further, for example, the preferred ear of the wearer 12 can be determined by determining the angle 310 between the direction 320 that the wearer 12 is looking and the median plane 308 of the wearer.

At 414, binaural localization cues can optionally be provided to the wearer 12 using any suitable technique. Further, the first audio signal and the second audio signal can optionally be analyzed at 416 to determine a position of the acoustic source 300 relative to the frontal plane 306 of the wearer 12 using any suitable technique.

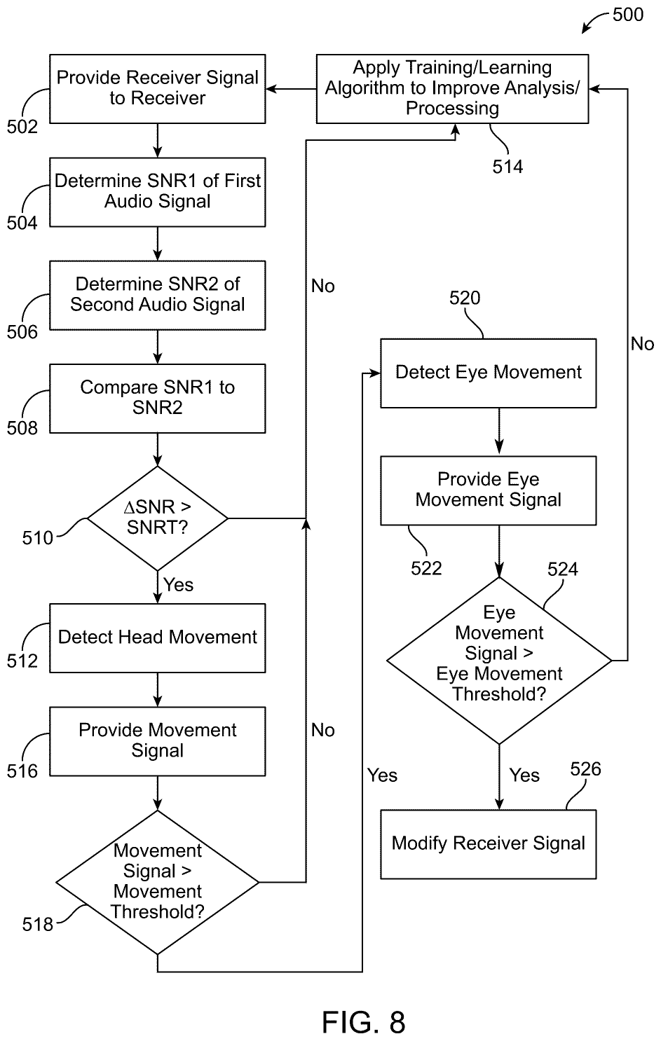

FIG. 8 is a flowchart of a method 500 of enhancing audio signals utilizing the hearing device system 10 of FIGS. 1-4. Although described regarding device system 10 of FIGS. 1-4, the method 500 can be utilized with any suitable hearing device system. At 502, the receiver signal can be provided to the receiver 204 based on at least one of the first audio signal or the second audio signal. The first signal-to-noise ratio (SNR1) of the first audio signal can be determined at 504 using any suitable technique. Further, at 506, the second signal-to-noise ratio (SNR2) of the second audio signal can be determined utilizing any suitable technique. At 508, SNR1 can be compared to SNR2 utilizing any suitable technique. The receiver signal can be modified at 510 based on a difference between SNR1 and SNR2 (ΔSNR). For example, if the absolute value of the difference between SNR1 and SNR2 (ΔSNR) is greater than the signal-to-noise ratio threshold (SNRT), then head movement of the wearer can be sensed at 512 using the movement sensor 210. If, however, ΔSNR is equal to or less than SNRT at 510, then the receiver signal is not modified and the method 500 returns to 514, where a training and learning algorithm to improve analysis and processing can be utilized and the method is returned to 502. Any suitable training/learning algorithm can be utilized at 514.

At 516, the head movement signal can be provided to the controller 206 using any suitable technique. For example, the movement sensor 210 can be utilized to sense head or body movement and provide the movement signal. At 518, if the head movement signal is greater than a head movement threshold, then the receiver signal can be modified based upon the comparison of SNR1 and SNR2 and the head movement signal. If, however, the head movement signal is equal to or less than the head movement threshold, then the method 500 returns to 514 where the training/learning algorithm can be utilized and the method is returned to 502.

At 520, eye movement can be detected using any suitable technique. For example, the eye sensor 212 can be utilized to sense eye movement. At 522, the eye movement signal from the eye sensor 212 can be provided to the controller 206 at 522. The eye movement signal can be determined utilizing any suitable technique. In one or more embodiments, a direction of movement of one or both eyes can be utilized to provide the eye movement signal. In one or more embodiments, the angle 310 between the direction 320 the wearer is looking and the median plane 308 of the wearer 12 can be determined as shown in FIG. 6 to provide the eye movement signal. At 524, if the eye movement signal is greater than an eye movement threshold, then the receiver signal can be modified using any suitable technique at 526. If, however, the eye movement signal is equal to or less than the eye movement threshold, then the method 500 returns to 514 where the training/learning algorithm is applied and the method is returned to 502.

All references and publications cited herein are expressly incorporated herein by reference in their entirety into this disclosure, except to the extent they can directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. A hearing device system comprising:
a first hearing device configured to be disposed on or in a first ear of a wearer and comprising a microphone that is configured to sense acoustic waves from an environment of the wearer and convert the sensed acoustic waves to a first audio signal;
a second hearing device configured to be disposed on or in a second ear of the wearer and comprising a microphone that is configured to sense acoustic waves from the environment of the wearer and convert the sensed acoustic waves to a second audio signal;
a receiver operatively coupled to one or both of the first hearing device and the second hearing device and configured to:
be in fluid communication with the first ear or the second ear; and
output acoustic energy based on a receiver signal; and
a controller configured to:
provide the receiver signal to the receiver based on at least one of the first audio signal or second audio signal;
determine a first signal to noise ratio of the first audio signal;
determine a second signal to noise ratio of the second audio signal;
compare the first signal to noise ratio and the second signal to noise ratio; and
modify the receiver signal based on a difference between the first signal to noise ratio and the second signal to noise ratio.

2. The system of claim 1, wherein to modify the receiver signal the controller is further configured to modify the receiver signal if the difference between the first signal to noise ratio and the second signal to noise ratio is greater than a signal to noise ratio difference threshold.

3. The system of claim 1, wherein to modify the receiver signal the controller is further configured to increase a gain in the receiver signal of either the first audio signal or second audio signal having the greatest signal to noise ratio.

4. The system of claim 1, wherein to modify the receiver signal the controller is further configured to increase clarity in the receiver signal of either the first audio signal or second audio signal having the greatest signal to noise ratio.

5. The system of claim 1, wherein to modify the receiver signal the controller is further configured to provide in the receiver signal either the first audio signal or second audio signal having the greatest signal to noise ratio to each of the first ear and second ear.

6. The system of claim 1, wherein the controller is further configured to determine a preferred ear of the wearer.

7. The system of claim 6, wherein to determine the preferred ear of the wearer the controller is further configured to identify which of the first audio signal or second audio signal has the greatest signal to noise ratio.

8. The system of claim 6, wherein at least one of the first hearing device or second hearing device further comprises an inertial measurement unit (IMU) operatively connected to the controller and configured to detect motion of a head of the wearer and provide a movement signal to the controller, wherein to determine the preferred ear of the wearer the controller is further configured to determine an angle between a median plane of the wearer and an axis that extends between the head of the wearer and an acoustic source relative to either a first ear side of the head or a second ear side of the head.

9. The system of claim 6, further comprising an eye sensor operatively connected to the controller, wherein the eye sensor is configured to detect eye movement of at least one eye of the wearer and provide an eye movement signal to the controller, wherein to determine the preferred ear of the wearer the controller is further configured to determine motion of at least one eye of the wearer in relation to motion of a head of the wearer.

10. A hearing device system comprising:
a first hearing device configured to be disposed on or in a first ear of a wearer and comprising a microphone that is configured to sense acoustic waves from an environment of the wearer and convert the sensed acoustic waves to a first audio signal;
a second hearing device configured to be disposed on or in a second ear of the wearer and comprising a microphone that is configured to sense acoustic waves from the environment and convert the sensed acoustic waves to a second audio signal;
a movement sensor configured to sense movement of a head of the wearer and provide a movement signal based on the sensed movement;
a receiver operatively coupled to one or both of the first hearing device and the second hearing device and configured to:
be in fluid communication with the first ear or the second ear; and
output acoustic energy based on a receiver signal; and
a controller configured to:
receive the movement signal;
provide the receiver signal to the receiver based on the movement signal and at least one of the first audio signal or second audio signal;
determine a first signal to noise ratio of the first audio signal;
determine a second signal to noise ratio of the second audio signal;
compare the first signal to noise ratio and the second signal to noise ratio; and
modify the receiver signal based on the movement signal and a difference between the first signal to noise ratio and the second signal to noise ratio.

11. The system of claim 10, wherein the controller is further configured to determine a preferred ear of the wearer based on the movement signal.

12. The system of claim 10, wherein the movement sensor comprises an inertial measurement unit (IMU).

13. The system of claim 10, further comprising an eye sensor operatively connected to the controller, wherein the eye sensor is configured to detect eye movement of at least one eye of the wearer and provide an eye movement signal, wherein to modify the receiver signal the controller is further configured to modify the receiver signal based on the movement signal, the eye movement signal, and a difference between the first signal to noise ratio and the second signal to noise ratio.

14. The system of claim 10, wherein the controller is further configured to provide binaural localization cues to the wearer.

15. The system of claim 14, wherein the controller is further configured to analyze the movement signal, the first audio signal, and the second audio signal to determine a position of an acoustic source relative to a median plane of the wearer.

16. A method comprising:
providing a receiver signal to a receiver of a hearing device system based on at least one of a first audio signal or second audio signal, wherein the first audio signal is converted by a microphone of a first hearing device from acoustic waves from an environment of a wearer sensed by the microphone, wherein the second audio signal is converted by a microphone of a second hearing device from acoustic waves from the environment of the wearer sensed by the microphone, and wherein the first hearing device is configured to be disposed on or in a first ear of the wearer and the second hearing device is configured to be disposed on or in a second ear of the wearer;
determining a first signal to noise ratio of the first audio signal;
determining a second signal to noise ratio of the second audio signal;
comparing the first signal to noise ratio and the second signal to noise ratio; and
modifying the receiver signal based on a difference between the first signal to noise ratio and the second signal to noise ratio.

17. The method of claim 16, wherein modifying the receiver signal comprises modifying the receiver signal if the difference between the first signal to noise ratio and the second signal to noise ratio is greater than a signal to noise ratio difference threshold.

18. The method of claim 16, wherein modifying the receiver signal comprises increasing a gain in the receiver signal of either the first audio signal or second audio signal having the greatest signal to noise ratio.

19. The method of claim 16, wherein modifying the receiver signal comprises providing in the receiver signal either the first audio signal or second audio signal having the greatest signal to noise ratio to each of the first ear and second ear.

20. The method of claim 16, further comprising determining a preferred ear of the wearer.
